(19) United States
(12) Patent Application Publication
(10) Pub. No.: US 2019/0274285 A1
(43) Pub. Date: Sep. 12, 2019

(54) FLEXIBLE MATERIAL FOR USE IN PET TOYS AND OTHER OBJECTS AND METHOD FOR MANUFACTURING SAID MATERIAL

(71) Applicant: Caltec Corporation, Halethorpe, MD (US)

(72) Inventors: John James STONE, Golden, CO (US); Amy E. STONE, Golden, CO (US)

(21) Appl. No.: 16/298,876

(22) Filed: Mar. 11, 2019

Related U.S. Application Data
(60) Provisional application No. 62/641,490, filed on Mar. 12, 2018.

(51) Int. Cl. A01K 15/02; G10K 15/04; B32B 5/02; B32B 27/36; B32B 7/12; B32B 27/12

(52) U.S. Cl. CPC A01K 15/026; G10K 15/04; B32B 5/024; B32B 27/36; B32B 2307/10; B32B 7/12; B32B 27/12; B32B 2262/0276; B32B 5/028

(57) ABSTRACT

A chewable dog toy formed of a multi-ply fabric material including a base material and a lining material formed of a crinkle material and bonded to an inner surface of the base material by a heat activated adhesive, wherein the lining material makes an audible sound when the base material is physically manipulated, wherein the thickness of the lining material corresponds to a sound level for the audible sound being emitted, such that the thickness can be selectively increased or decreased to respectively increase or decrease the volume of the emitted audible sound, and wherein the outer surface of the base material forms an exterior appearance of the chewable dog toy.

### CROSS REFERENCE TO RELATED APPLICATION

The present application claims priority to U.S. Provisional Application No. 62/641,490, filed Mar. 12, 2018, the entire contents of which is incorporated herein for all purposes by this reference.

### TECHNICAL FIELD

This application relates to flexible material that can be used to manufacture pet toys, and more particularly, to a sheet-like material that can generate or emit audible sounds or noises, particularly when physically contacted or manipulated such as by a dog or other pet.

### BACKGROUND

The present disclosure provides a flexible material for generating or emitting audible sounds or noises that can be used to manufacture pet toys wherein the flexible material is stronger, more durable and more resilient than conventional fabric or sheet material.

Currently, many conventional toys for dogs and other pets employ some form of “noise-maker” for generating audible sounds and/or “crunching” noises that are generally enjoyable to pets, as well as other animals and their companions. Although designs differ, one common existing approach is to utilize a whistle or other similar noise generating device mounted on or inside a toy, wherein said noise generating device emits an audible sound when air or other fluid passes through the device when force is applied to a toy. In many cases, a toy is designed with an inner chamber or hollow section that is at least partially collapsible so that the toy can mimic or act like a bellows—the toy emits a stream of air when squeezed together, such as when a dog or other pet bites down on or otherwise compresses the toy. This stream of air is directed through said noise generating device to emit an audible sound that is pleasing to the dog (or other pet) when the dog bites down on the toy.

Such conventional sound-emitting toys suffer from a number of significant limitations. Namely, said toys typically must be specifically designed to accommodate placement of a sound-emitting device, and/or to create a fully or partially collapsible inner chamber, which can be costly and prohibitive. In some cases, such sound-emitting devices can become dislodged or separated from a toy, thereby eliminating such noise generation characteristics of the toy while also creating a potential choking hazard for a pet.

For the aforementioned reasons, there is a need for a material that can be used for the manufacture of various objects such as pet toys including, without limitation, chewable dog toys. The material should be stronger, more durable and/or more resilient than conventional fabric. The material should be capable of generating or emitting audible sounds or noises, particularly when physically contacted or manipulated by a pet (such as a dog) or other external force acting on said material. However, such technologies do not exist. Accordingly, this disclosure enables such technologies.

### SUMMARY

To achieve the foregoing objects, and in accordance with the purpose of the invention as embodied and broadly described herein, there is provided a multi-ply fabric material for a pet toy including: a base material including at least an outer layer formed of a plush textile, a middle layer formed of a mesh material, and an inside layer formed of a dense fiber material; and a lining material formed of a crinkle material and bonded to an inner surface of the inside layer of the base material by a heat activated adhesive; wherein the lining material makes an audible sound when the base material is physically manipulated, and wherein the thickness of the lining material corresponds to a volume for the audible sound being emitted, such that the thickness can be selectively increased or decreased to respectively increase or decrease the volume of the emitted audible sound.

According to an embodiment of the invention, the plush textile of the outer layer is a low, a medium, or a high pile plush textile; the mesh material of the middle layer is a polyester mesh material; and the dense fiber material of the inside layer is a woven polyester material.

According to an embodiment of the invention, the crinkle material of the lining material is a polyethylene terephthalate (PET) material.

According to an embodiment of the invention, the thickness of the lining material is between 0.8 mm-0.12 mm.

According to an embodiment of the invention, the audible sound is a “crunching” sound.

According to yet another embodiment of the invention, a plush toy formed of a multi-ply fabric material includes: a base material including at least an outer layer formed of a plush textile, a middle layer formed of a mesh material, and an inside layer formed of a dense fiber material; and a lining material formed of a crinkle material and bonded to an inner surface of the inside layer of the base material by a heat activated adhesive, wherein the lining material makes an audible sound when the base material is physically manipulated, wherein the thickness of the lining material corresponds to a sound level for the audible sound being emitted, such that the thickness can be selectively increased or decreased to respectively increase or decrease the volume of the emitted audible sound, and wherein the outer layer of the base material forms an exterior appearance of the plush toy.

According to still another embodiment of the invention chewable dog toy formed of a multi-ply fabric material includes: a base material; and a lining material formed of a crinkle material and bonded to an inner surface of the base material by a heat activated adhesive; wherein the lining material makes an audible sound when the base material is physically manipulated, wherein the thickness of the lining material corresponds to a sound level for the audible sound being emitted, such that the thickness can be selectively increased or decreased to respectively increase or decrease the volume of the emitted audible sound, and wherein the outer surface of the base material forms an exterior appearance of the chewable dog toy.

### BRIEF DESCRIPTION OF THE DRAWINGS

The accompanying drawings constitute a part of this specification and illustrate an embodiment of the present disclosure and together with the specification, explain the present disclosure.

FIG. 1 shows a perspective view of an exemplar multi-ply material used to form a pet toy according to an embodiment of the present disclosure.

FIG. 2 shows a side view of the exemplar multi-ply material shown in FIG. 1

### DETAILED DESCRIPTION OF THE PREFERRED EMBODIMENTS

Reference will now be made to the exemplary embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to a person skilled in the relevant art and having possession of this disclosure, are to be considered within the scope of the invention.

As used herein, various singular forms “a,” “an” and “the” are intended to include various plural forms as well, unless context clearly indicates otherwise. For example, a term “a” or “an” shall mean “one or more,” even though a phrase “one or more” is also used herein. Use of the optional plural “(s),” “(es),” or “(ies)” means that one or more of the indicated feature is present.

As used herein, a term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, features described with respect to certain embodiments may be combined in or with various other embodiments in any permutational or combinatory manner. Different aspects or elements of example embodiments, as disclosed herein, may be combined in a similar manner.

Various terminology used herein can imply direct or indirect, full or partial, temporary or permanent, action or inaction. For example, when an element is referred to as being “on,” “connected” or “coupled” to another element, then the element can be directly on, connected or coupled to the other element or intervening elements can be present, including indirect or direct variants. In contrast, when an element is referred to as being “directly connected” or “directly coupled” to another element, there are no intervening elements present.

The term “fabric” is used to mean a cloth made from natural fiber, synthetic fiber, or a combination of both.

The term “geometrically-shaped” as used herein includes circular, polygon, rectangular, square, and triangular shapes.

The present invention comprises a material that can be used for the manufacture of various objects such as pet toys including, without limitation, chewable dog toys. The material is stronger, more durable, and more resilient than conventional fabric or synthetic sheet material. In a preferred embodiment, the material should be capable of generating or emitting audible sounds or noises, particularly when physically contacted or manipulated by a pet (such as a dog) or other external force acting on said material.

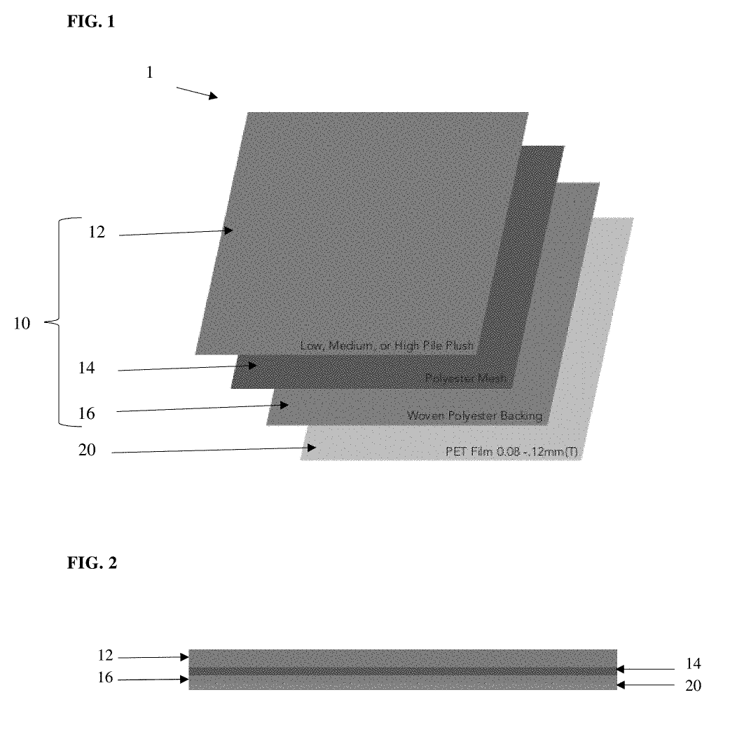

FIG. 1 depicts a perspective view of a material 10 having a multi-ply construction that may be used to make a toy such as a pet toy or stuffed animal according to an embodiment of the invention. The material 1 may comprise a base material 10 and a lining material 20.

The base material 10 may be used to manufacture or form all or part of another object or item such as, for example, a pet toy or stuffed animal. For example, the base material may form an exterior of the pet toy or stuffed animal. The base material 10 may comprise a natural or synthetic, single or multiple fabric material. The base material 10 may comprise a sheet-like material; however, it is understood that the base material 10 may comprise any number of different known materials or combinations that exhibit desired characteristics including, without limitation, shape, thickness, strength, tear and/or puncture resistance, texture, weight, color, cost and ease of use with other materials.

The lining material 20 is laminated, bonded or otherwise affixed to an inner surface of the base material 10 to provide strength and rigidity thereto. The lining material 20 is preferably a flexible sheet of material having desired strength and weight characteristics. The lining material 20 may be made of polyethylene terephthalate (PET), although it is understood that other materials may be utilized without departing from the scope of the invention. Preferably, the lining material 20 is formed of a crinkle material, such as Mylar® (polyethylene terephthalate), that will crinkle when a force is applied to thereto causing said material to deflect, bend or deform, thereby emitting an audible “crunching” sound. Thus, when the lining material 20 is deformed, it has the characteristics of producing a crinkling and crunching sound. For example, when a dog bits or otherwise compresses the material 1 of a pet toy, the lining material 20 is deformed causing a sound, such as a crinkling and/or crunching sound to be produced, thus encouraging the dog's interaction with the pet toy. Preferably, the lining material 20 if fully enclosed and sealed within an interior cavity of the pet toy such that it is not exposed to the outside of the pet toy.

The thickness of the lining material 20 may be adjusted to selectively affect the volume of said sound generated by the lining material 20. For example, the thickness can be increased in order to selectively increase the volume of audible sound generated by the lining material. Conversely, the thickness can be decreased in order to selectively decrease the volume of audible sound generated by the lining material. Having different volume options for pet toys and baby toys may be convenient for both pet owners and parents.

Below is an table comparing the thickness of the lining material 20 with sound volume and added durability to the material 1 according to an embodiment of the invention. As shown, the volume of the crunching sound and the durability of the material 1 are increased as the thickness of the lining material is increased. Conversely, as the volume of the crunching sound and the durability of the material 1 are decreased as the thickness of the lining material is decreased.

| Lining Material | Audible Sound | Added Durability |
|---|---|---|
| thickness | Volume produced | to Material |
| 0.08 mm | low | strong |
| 0.10 mm | medium | stronger |
| 0.12 mm | loud | strongest |

As shown in FIG. 1, in a preferred embodiment, a pet toy (any toy or stuffed animal) is formed of a material 1. The material 1 may comprise a base material 10 and a lining material 20. The base material 10 may comprise at least three layers: an outside layer 12, a middle layer 14, and an inside lawyer 16. The outside layer 12 (Layer 1) is preferably made of a custom designed plush fabric to provide an appropriate look and feel of the toy (e.g., to look like a monkey or hippo). For example, the outside layer 12 may be made of a fabric having a low, medium, or high pile plush material. The outside layer 12 may form the outer appearance of the pet toy. The middle layer 14 (Layer 2) is preferably made of a rugged or tear resistant sport mesh material, such as a polyester mesh. The inside layer 16 is preferably made of a heavy-duty dense fiber material that offers durability, such as, for example, a woven polyester. The outside layer 12, the middle layer 14, and the inside layer 16 together form the base material 10. The lining material 20 is affixed to an inner surface of the inside layer 16 by a heat activated adhesive applied thereto. The lining material 20 is preferably made of a PET film having a thickness corresponding to the desired volume of “crunching” sound and added durability of the multi-ply material 1. Preferably, the lining material 20 has a thickness between 0.08-0.12 mm (not limited thereto).

In view of the foregoing, when a toy for dogs or other pets is constructed using the material of the present invention, audible sounds are generated when said dog or other pet bites, bends, folds or manipulates said toy. Such noises are generally enjoyable to pets, as well as other animals and their companions, thereby motivating the pet to play with said toy.

Unlike conventional toys, pet toys constructed from the material 1 of the present invention need not be specifically designed to accommodate placement of a sound-emitting device, and/or to create a fully or partially collapsible inner chamber(s) within said toy. No additional sound-emitting device(s) are required, which helps to reduce manufacturing expense. Further, by eliminating such additional sound-emitting devices, potential choking hazards are eliminated.

The fabric material 1 of the present invention can be used for the manufacture of various objects such as pet toys including, without limitation, chewable dog toys. The material of the present invention is stronger, more durable and/or more resilient than conventional fabric. Further, the material of the present invention is capable of generating or emitting audible sounds or noises, particularly when physically contacted or manipulated by a pet (such as a dog) or other external force acting on said material.

The above-described invention has a number of particular features that should preferably be employed in combination, although each is useful separately without departure from the scope of the invention. While the preferred embodiments of the present invention are shown and described herein, it will be understood that the invention may be embodied otherwise than herein specifically illustrated or described, and that certain changes in form and arrangement of parts and the specific manner of practicing the invention may be made within the underlying idea or principles of the invention.

Although the invention is described herein with reference to specific embodiments, it is understood that various modifications and changes can be made without departing from the scope of the present invention.

What is claimed is:

1. A multi-ply fabric material for a pet toy comprising:
a base material comprising at least an outer layer formed of a plush textile, a middle layer formed of a mesh material, and an inside layer formed of a dense fiber material; and
a lining material formed of a crinkle material and bonded to an inner surface of the inside layer of the base material by a heat activated adhesive,
wherein the lining material makes an audible sound when the base material is physically manipulated, and
wherein the thickness of the lining material corresponds to a volume for the audible sound being emitted, such that the thickness can be selectively increased or decreased to respectively increase or decrease the volume of the emitted audible sound.

2. The multi-ply fabric material of claim 1, wherein the plush textile of the outer layer is a low, a medium, or a high pile plush textile.

3. The multi-ply fabric material of claim 2, wherein the mesh material of the middle layer is a polyester mesh material.

4. The multi-ply fabric material of claim 3, wherein the dense fiber material of the inside layer is a woven polyester material.

5. The multi-ply fabric material of claim 4, wherein the crinkle material of the lining material is a polyethylene terephthalate (PET) material.

6. The multi-ply fabric material of claim 5, wherein the thickness of the lining material is between 0.8 mm-0.12 mm.

7. The multi-ply fabric material of claim 5, wherein the thickness of the lining material is less than or equal to 0.10 mm.

8. The multi-ply fabric material of claim 5, wherein the thickness of the lining material is less than or equal to 0.08 mm.

9. The multi-ply fabric material of claim 5, wherein the audible sound is a “crunching” sound.

10. A plush toy formed of a multi-ply fabric material comprising:
a base material comprising at least an outer layer formed of a plush textile, a middle layer formed of a mesh material, and an inside layer formed of a dense fiber material; and
a lining material formed of a crinkle material and bonded to an inner surface of the inside layer of the base material by a heat activated adhesive,
wherein the lining material makes an audible sound when the base material is physically manipulated,
wherein the thickness of the lining material corresponds to a sound level for the audible sound being emitted, such that the thickness can be selectively increased or decreased to respectively increase or decrease the volume of the emitted audible sound, and
wherein the outer layer of the base material forms an exterior appearance of the plush toy.

11. The multi-ply fabric material of claim 10, wherein the plush textile of the outer layer is a low, a medium, or a high pile plush textile.

12. The multi-ply fabric material of claim 11, wherein the mesh material of the middle layer is a polyester mesh material.

13. The multi-ply fabric material of claim 12, wherein the dense fiber material of the inside layer is a woven polyester material.

14. The multi-ply fabric material of claim 13, wherein the crinkle material of the lining material is a polyethylene terephthalate (PET) material.

15. The multi-ply fabric material of claim 14, wherein the thickness of the lining material is between 0.8 mm-0.12 mm.

16. The multi-ply fabric material of claim 14, wherein the thickness of the lining material is less than or equal to 0.10 mm.

17. The multi-ply fabric material of claim 14, wherein the thickness of the lining material is less than or equal to 0.08 mm.

18. The multi-ply fabric material of claim 15, wherein the audible sound is a “crunching” sound.

19. The multi-ply fabric material of claim 15, wherein the plush toy is a chewable dog toy.

20. A chewable dog toy formed of a multi-ply fabric material comprising:
a base material; and
a lining material formed of a crinkle material and bonded to an inner surface of the base material by a heat activated adhesive;
wherein the lining material makes an audible sound when the base material is physically manipulated,
wherein the thickness of the lining material corresponds to a sound level for the audible sound being emitted, such that the thickness can be selectively increased or decreased to respectively increase or decrease the volume of the emitted audible sound, and
wherein the outer surface of the base material forms an exterior appearance of the chewable dog toy.
